(19) United States
(12) Patent Application Publication
(10) Pub. No.: US 2004/0064328 A1
(43) Pub. Date: Apr. 1, 2004

(54) Compliance with organizational standards

(76) Inventor: Roger T. Keranen, Oak Park, MI (US)

Correspondence Address: Mr. Walter J. Tencza Jr., Suite 3, 10 Station Place, Metuchen, NJ, 08840, US

(21) Appl. No.: 10/263,935

(22) Filed: Oct. 1, 2002

(51) Int. Cl. G06F 17/60

(52) U.S. Cl. 705/1

(57) ABSTRACT

An integrated system for standard registration is provided. The first part of the integrated system a lean documentation system that knows exactly how the registrar will test the organization's quality management system and supplies the organization with one page flow charts that comply with the applicable standard. The second part of the integrated system is applying a near paperless document control software that manages the launch and maintenance of the procedures and quality records and instant reporting. The third part of the integrated system is a powerful database software that receives data from the electronic forms to populate relational database tables.

### FIELD OF THE INVENTION

This invention relates to improved methods and apparatus concerning implementation of quality, environmental, and/or automotive standards for organizations, such as the standards of the International Standards Organization in Geneva.

### BACKGROUND OF THE INVENTION

The International Standards Organization (“ISO”) in Geneva provides standards, which relate to quality management and/or environmental management for businesses. For example, the ISO provides an ISO 9000 family of standards, which for the most part relates to quality management. Generally speaking “quality management” as the term is used in the ISO 9000 family of standards, means what the business does to make certain that its products (or services) comply with a customer's requirements. The ISO also provides an ISO 14000 family of standards, which for the most part relates to environmental management. Environmental management relates to what a business does to reduce deleterious effects on the environment caused by the business's activities. The ISO also provides an ISO/TS (International Standards Organization Technical Standard) 16949 standard which relates to quality management for automotive suppliers.

Many companies require that their suppliers be registered or certified to a particular ISO standard as good faith evidence that the suppliers have procedures and employee behaviors to comply with the particular ISO standard's requirements. Registration or certification to particular ISO standard, better assures long strings of product that is fit for customer use.

In the prior art, the business or organization that wanted to be registered had cultural change options that took enormous administrative efforts to get ready for a registration or certification audit conducted by an accredited auditor called a registrar. Novice quality managers and others often read the particular ISO standard and generally overreacted to their expectations of how the registrar would test for compliance to the particular ISO standard. When in doubt, the novice quality managers overreacted with excessive procedures and work instructions. Often, they misinterpreted the particular ISO standard's language and did not comply with the intent.

Still worse, these excessive, over zealous, documentation schemes were difficult to train affected parties effectively so there were plenty of audit findings, which had excessive audit abatement programs. Subsequent internal audits had to check on the effectiveness of prior findings until incidents were abated. The net affect was a quality or environmental management system was expensively launched and became an administrative burden to maintain. Unfortunately, there was not a bias to have individual task doers be responsible and be free to take action regarding the management of their own work area. In the prior art, expected quality assurance behaviors often did not actually trickle down to the employees who did the work.

### SUMMARY OF THE INVENTION

The present invention provides an integrated system for standard registration, such as ISO standard registration, as part of a particular business's fabric in day-to-day business practices. The integrated system can be site licensed to clients. The first part of the integrated system is the use a lean documentation system that knows exactly how the registrar will test the organization's quality management system and supplies the organization with one-page flow charts that comply with the applicable standard, such as an ISO standard. Additionally, the construction and facilitation of the documentation emphasizes the use of training as the effective method to achieving day-to-day employee quality assurance behaviors. Reliance on effective training instead of numerous work instructions is the core feature regarding the first part of this innovative business methodology.

The second part of the integrated system is applying a near paperless document control software that manages the launch and maintenance of the procedures and quality records and instant reporting. The software allows for electronic document approvals and routing leaving a clear audit trail. Electronic forms are provided that contain fields that must be completed prior to the control system's record release. Certain fields contain editing controls (alpha or numeric) to better assure the data has credibility.

The third part of the integrated system is a powerful database software that receives data from the electronic forms to populate relational database tables. Once the relational database tables are populated, customized reports are generated upon demand to deliver management reports in any time frame management desires.

The net effect is compliance to the particular ISO Standard through daily form entry from all affected parties that leaves an audit trail of employee identification, authorization, approval, and release of work that meets ISO and customer requirements. Additionally, data can be populated from a factory information system. Still additionally, organization data can be assembled from remote locations to provide an enterprise view, upon demand, for top executive management. ISO compliance is maintained seamlessly for effective internal audits that find less and less incidents over time.

### BRIEF DESCRIPTION OF THE DRAWINGS

FIG. 1 shows a flow chart of a prior art method of complying with an ISO standard;

FIG. 2 shows a block diagram of an apparatus including a client computer and a server computer for use in accordance with an embodiment of the present invention;

FIG. 3 shows a block diagram of an apparatus including a plurality of user computers and a server computer connected to a network, said apparatus for use in accordance with an embodiment of the present invention;

FIGS. 4A-4B show a flow chart of a method in accordance with an embodiment of the present invention of complying with an ISO standard;

FIG. 5 shows a cover sheet for a representative procedure in accordance with an embodiment of the present invention;

FIG. 6 shows a flow chart sheet for the representative procedure of FIG. 5;

FIG. 7 shows a representative form for data entry in accordance with an embodiment of the present invention;

FIG. 8 shows a nonconformance incident trend chart in accordance with an embodiment of the present invention;

FIG. 9 shows a year to date nonconforming incident analysis chart in accordance with an embodiment of the present invention;

FIG. 10A shows a cover sheet for a representative procedure in accordance with an embodiment of the present invention;

FIGS. 10B and 10C show a flow chart sheet for a part of the representative procedure of FIG. 10A; and

FIG. 10D shows a flow chart for a part of the representative procedure of FIG. 10D

### DETAILED DESCRIPTION OF THE DRAWINGS

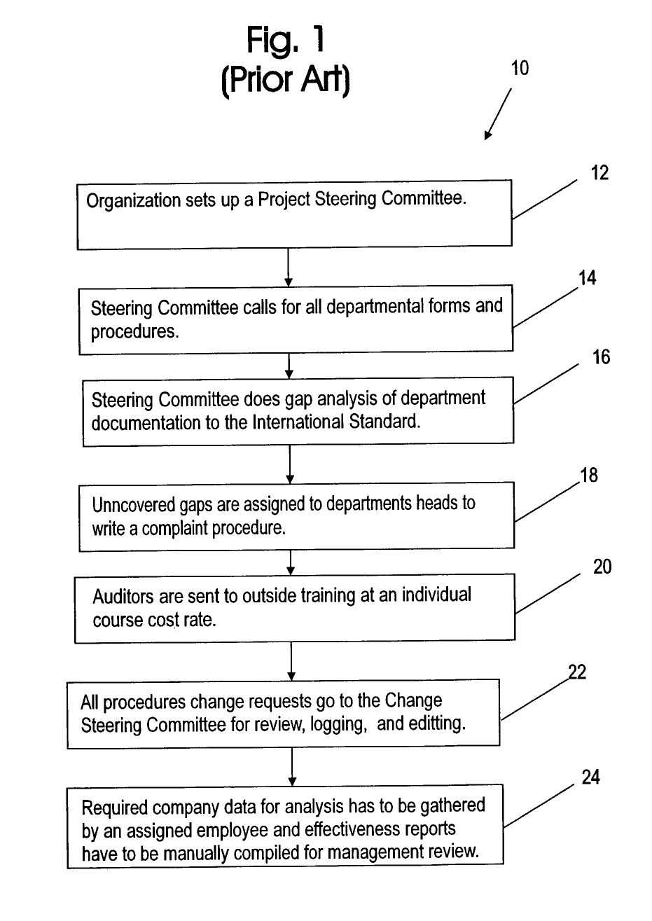

FIG. 1 shows a flow chart 10 of a prior art method for a particular business or organization to comply with an ISO standard. At step 12, the business sets up what is known as a “project steering” committee. Next at step 14, the project steering committee asks all department heads of the organization or other applicable personnel to provide all existing departmental forms and procedures. At step 16 the steering committee analyzes what must be done to the existing forms to change them for compliance with the applicable ISO standard, a process called “gap analysis”. At step 18 the steering committee assigns gaps, which they have uncovered to the applicable department heads or other appropriate personnel of the organization, so that the appropriate department heads can write a compliant procedure. The department head or heads write new procedures to cover compliance requirement at step 18. However, without the knowledge of the registrar to know how they will be tested, the new procedures are often excessively written to cover compliance requirements.

Often excessive departmental procedures and work instructions may number between one hundred twenty and three hundred. Forms prepared for changing over to the applicable ISO standard may number between two hundred and three hundred. Organizations often include business management processes into the quality management system that may bloat documentation and auditing time requirements.

At step 20 in the prior art, auditors internal to the organization are sent for outside training regarding the applicable ISO standard, typically at an individual course cost rate. The company has no guideline to determine auditor staff size. Often, too few auditors are trained due to budget concerns. An auditor outside training class of the prior art typically does not have case studies and use of the participant company's auditing reporting forms like the Audit Findings Report and the Corrective Action Request. An auditor outside training class of the prior art typically does not have progressively smaller groups with named facilitators to practice internal lead auditor skills. Typically auditors do not have the class instructor come back to practice audit their company to provide instant feedback. Audit class materials do not include “ISO element auditing tips” for future audit assignments. The auditor outside training class of the prior art does not have pre and post testing to measure the class training effectiveness. Procedures are often text based and it may take up to twenty minutes to train each auditor regarding each procedure.

At step 22, typically all procedure change requests go to the steering committee for review, logging, and editing. This causes delay because typically the steering committee does not meet daily (usually bimonthly). Typically, in the prior art, a quality manual, which is comprised of a lengthy re-statement of the applicable ISO standard, is produced by the steering committee. The quality manual of the prior art is usually a long, clause-by-clause explanation of how the organization is responding to the particular ISO standard (the quality manual of the prior art may be forty to fifty pages in length). In the prior art, the published quality management system is not integrated into the fabric of the organization's administrative processes. At step 24, required company data for analysis has to be gathered by an assigned employee and effectiveness reports have to be manually compiled for management review. Data analysis review periods are often quarterly or semi-annual due to the time to compile data and report.

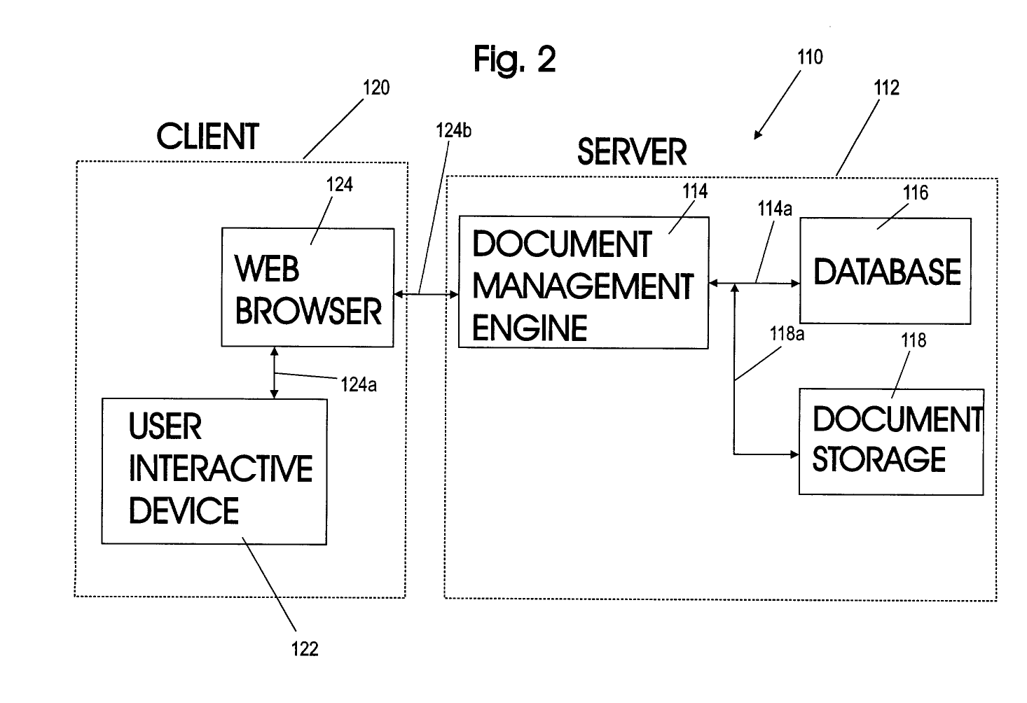

FIG. 2 shows a block diagram of an apparatus 110 including a client computer 120 and a server computer 112 for use in accordance with an embodiment of the present invention. The server computer 112 and the client computer 120 may be typical personal computers each comprised of a monitor, keyboard, mouse, computer processor and other typical components. The client computer 120 may be comprised of a web browser 124 and a user interactive device 122. The web browser 124 may be computer software running on a computer processor of the client computer 120. The user interactive device 122 may be a computer mouse and/or keyboard. The web browser 124 may be electrically connected by link 124a to the user interactive device 122. The client computer 120 may be electrically connected by link 124b to the server computer 112. Link 124b may include, for example a communications link over the Internet. Electrical connections or communications links may be comprised of wireless, optical, hardwired, software links, or any other type of communications links.

The server computer 112 may be comprised of a document management engine 114 and a database 116 which may be comprised of computer software running on a computer processor of the server computer 112. The server computer 112 may also include document storage 118 which may include electronic memory such as RAM or ROM or any other computer memory for storage of electronic documents. The document management engine 114 may be electrically connected by link 114a to database 116. Document storage 118 may be electrically connected to link 114a and thus to database 116 and to document management engine 114.

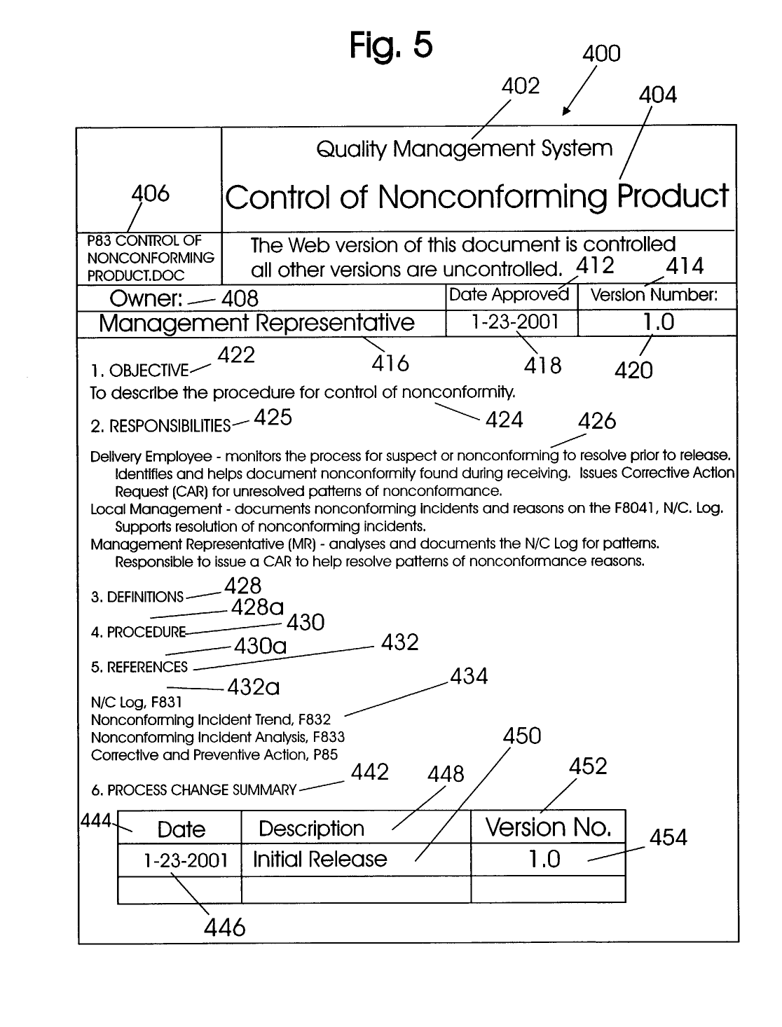

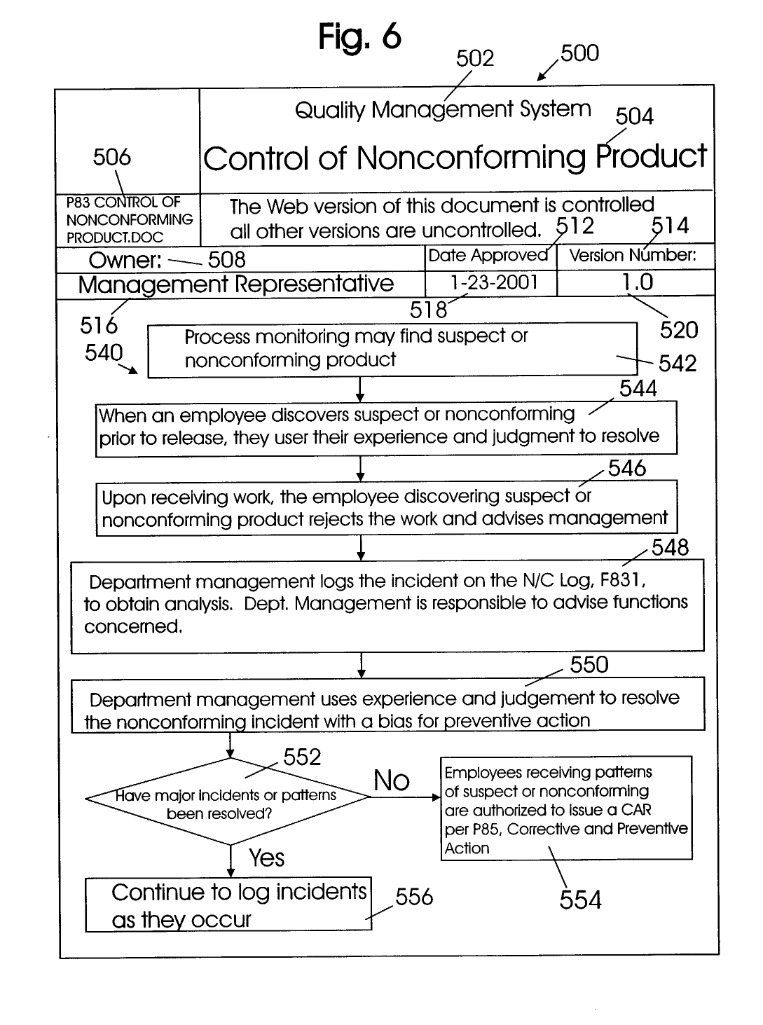

A user of the client computer 120 can view procedures (such as procedures to be described with reference to FIGS. 5 and 6) and work instructions for reference and training, obtain blank form templates for complying with quality processes, generate reports on quality objectives or progress on fixing audit findings or formal corrective actions for possible management intervention or printing, input data on quality assurance logs like customer supplied product or nonconforming incidents, and assign document routing for approvals like requesting training or sending copies of minutes to attendees.

FIG. 2 shows the relationship that exists between the user, the web browser 124, the document management engine 114, the relational database 116, and the document storage device 118 to achieve a nearly paperless, integrated, quality management system, where daily activities automatically are compliant to the requirements of registration for a particular ISO standard. Such an integrated system is achievable at one site or as a compliance tool for any “n” number of sites.

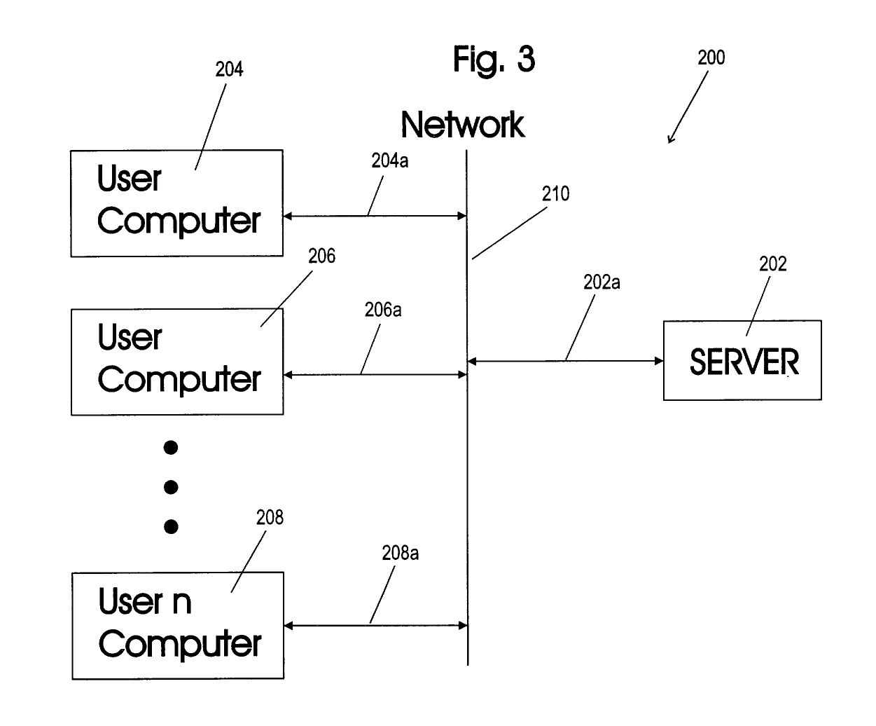

FIG. 3 shows a block diagram of an apparatus 200 including a plurality of user computers and a server computer 202 connected to a network 210, said apparatus 200 for use in accordance with an embodiment of the present invention. The plurality of user computers includes user computer 204, user computer 206, and user n computer 208. Each user computer is electrically connected to the network 210. The network 210 may be a local area network, a wide area network (intranet) or the Internet. The server computer 202 is electrically connected to the network 210 by link 202a. The server 202 of FIG. 3 may be the same as the server computer 112 of FIG. 2. Any one of the user computers 204, 206, and 208 of FIG. 3 may be the same as the client computer 120 of FIG. 2.

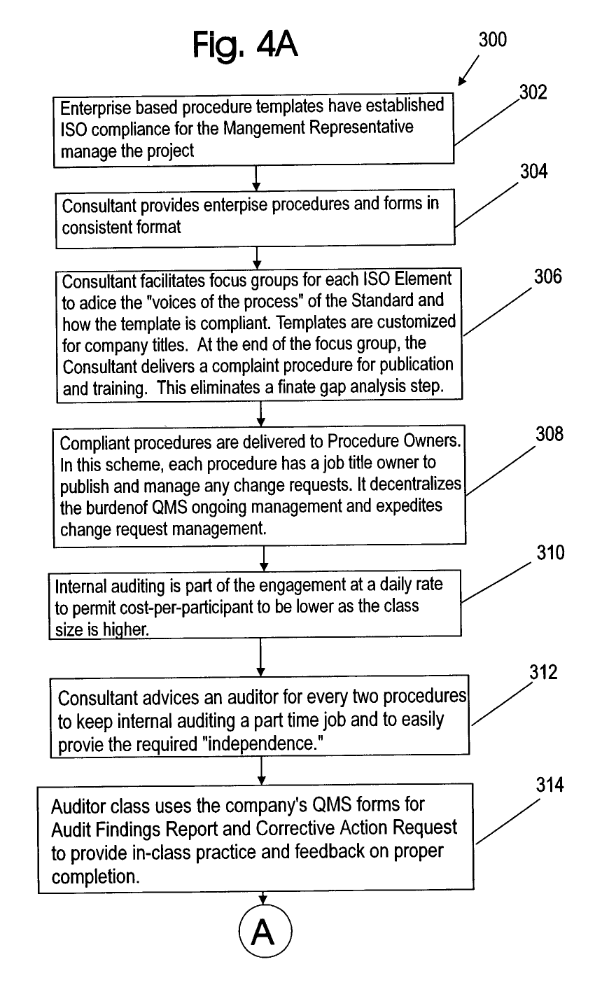

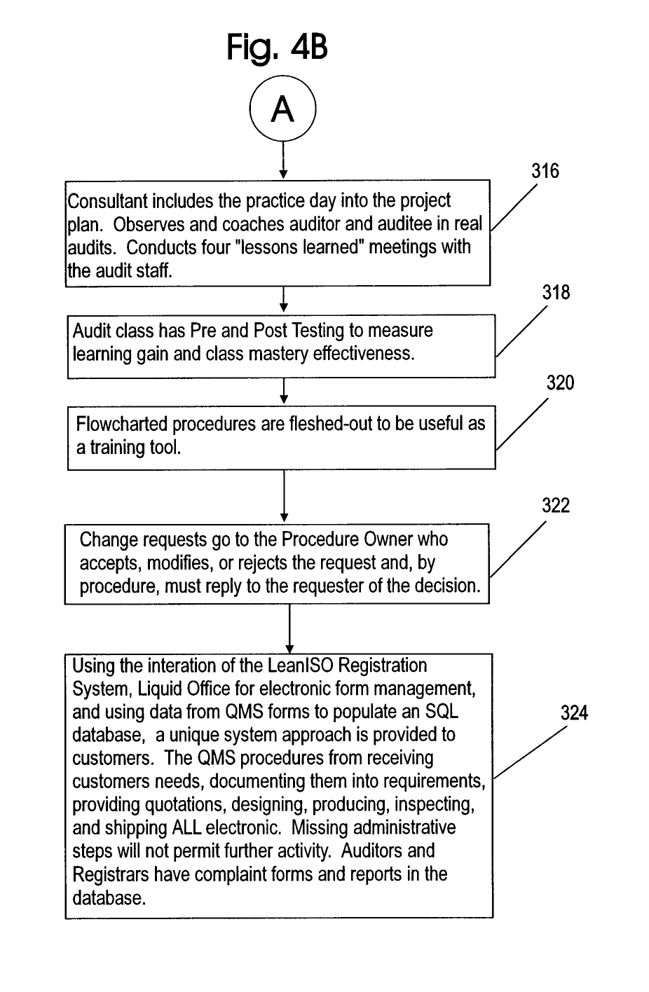

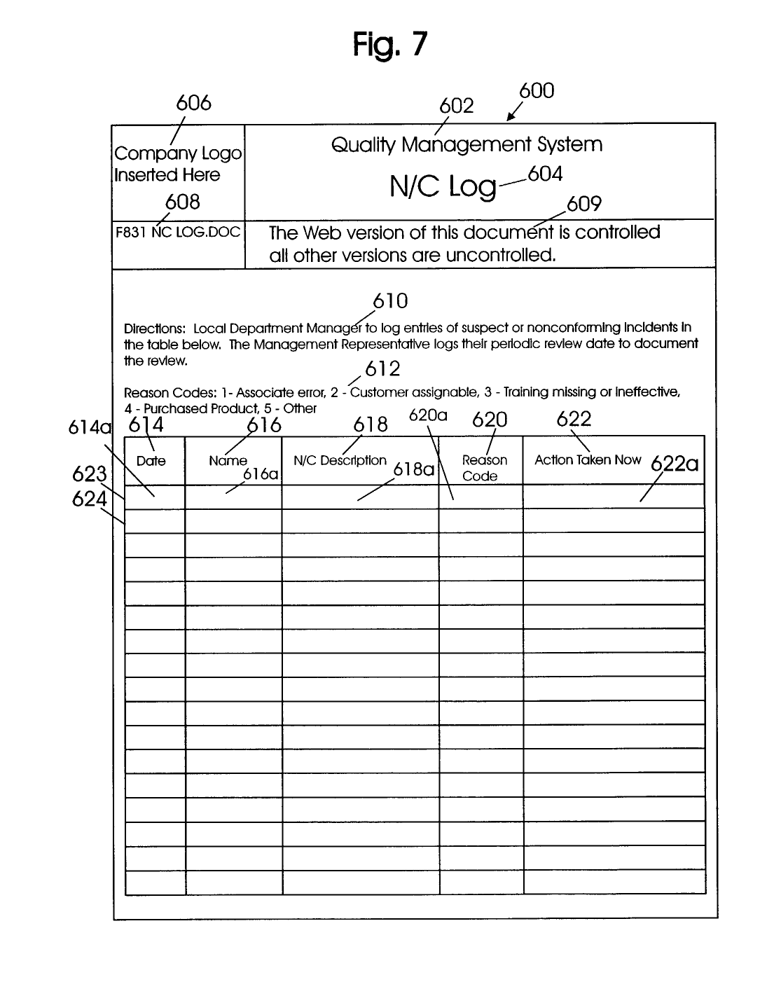

FIGS. 4A-4B show a flow chart 300 of a method in accordance with an embodiment of the present invention. The tasks taken in FIGS. 4A and 4B establish a lean response to the requirements of a particular ISO Standard where organization employees are trained on their roles inside the quality management system and are advised how they will use the integrated system in their daily quality assurance activities to permit effective use, maintenance and auditing. The quality management system templates and forms, such as form 600 of FIG. 7, are inserted into the server computer 112 or 202 with the procedures, such as the procedure shown by FIGS. 5 and 6, stored in the Document Storage, 118. The forms are stored in the Document Management Engine, 114, and the form's data is stored in the Database, 116, for generating desired reports.

At step 302 of the flow chart 300 of FIGS. 4A-4B, enterprise based procedure templates, such as the procedure shown by FIGS. 5 and 6, have established ISO compliance for the management representative managing the project. An example of an enterprise procedure where all employees are trained to respond to unexpected events is shown by FIGS. 5-7. FIG. 5 shows a cover sheet 400 for a representative procedure, in accordance with an embodiment of the present invention. FIG. 6 shows a flow chart sheet 500, or template for the representative procedure of FIG. 5. FIG. 7 shows a representative form 600 for data entry in accordance with an embodiment of the present invention. The cover sheet 400, flow chart sheet 500, and form 600 may be computer documents located on the server computer 112 of FIG. 2 or the server computer 202 of FIG. 3. The cover sheets, such as cover sheet 400, flow chart sheets, such as flow chart sheet 500, and forms, such as form 600, typically reside on the server computer 112 with read only access to prevent unauthorized changes to previously approved, and now, controlled documents. Data entry to forms is managed by the Document Management Engine 114 shown in FIG. 2.

The cover sheet 400 of FIG. 5 may include fields 402, 404, 406, 408, 412, 414, 416, 418, 420, 422, 424, 425, 426, 428, 430, 432, 434, 436, 438, 440, 442, 444, 446, 448, 450, 452, and 454. Field 402 may specify the title of “Quality Management System”. Field 404 may specify the procedure, which in this example is “Control of Nonconforming Product”. Field 406 may specify an abbreviation for the procedure form, which in this case is “P83”, and a title of a computer document on which the procedure cover sheet 400 and/or the flow chart 500 for the procedure may be stored which in this case is “Control of Nonconforming Product.Doc”. Field 414 may specify that the version of the cover sheet 400 on a web site or on the Internet is controlled meaning that it can be manipulated only by the Web Administrator or person in control of server computer 112 and that all other versions are uncontrolled meaning there is no guarantee as to their accuracy.

Field 408 may specify the word “Owner:” and the “Owner” of the procedure can be entered into field 416, and is shown in this case as “Management Representative”. The “Owner” of a procedure is the Job Title at the company that is responsible for implementing the procedure. Job titles are used so that when individuals move, there is no need to change all the associated records. Fields 412 and 414 specify the phrases “Date Approved” and “Version Number”, respectively. Fields 418 and 420 show the date the procedure shown by cover sheet 400 and flow chart 500 was approved, and the version number of the procedure, respectively.

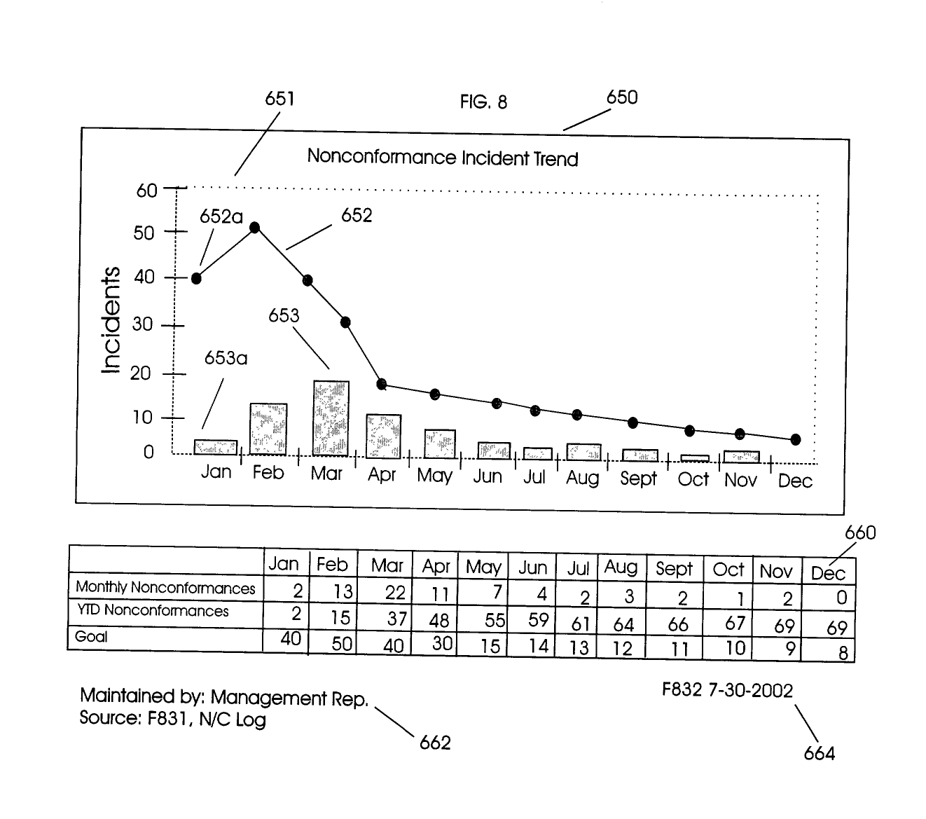

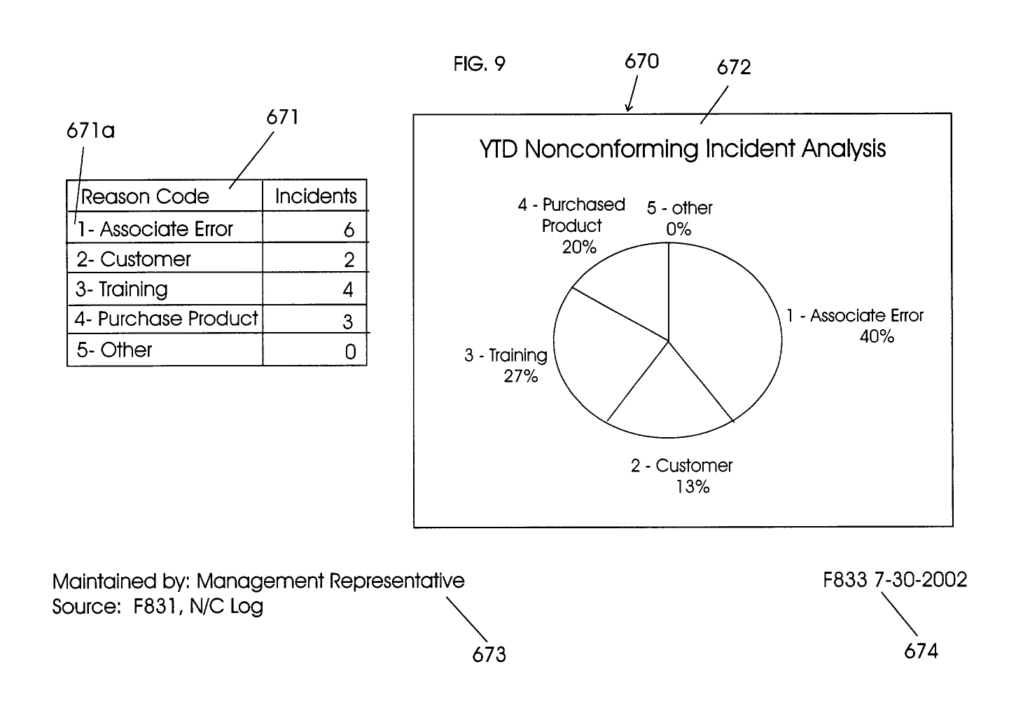

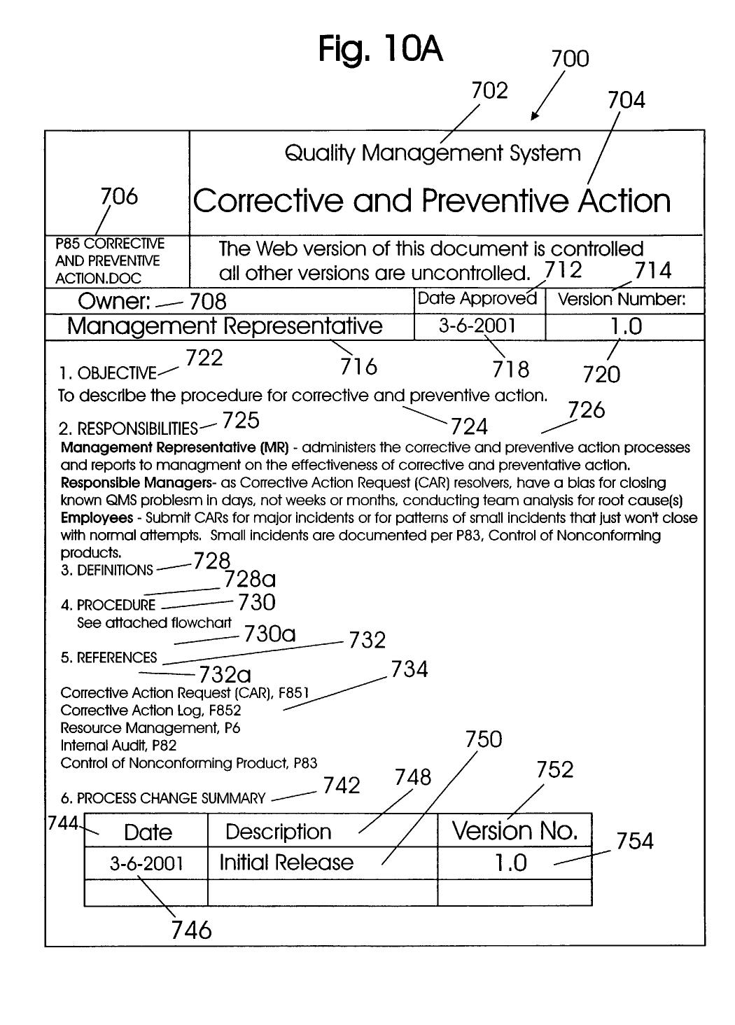

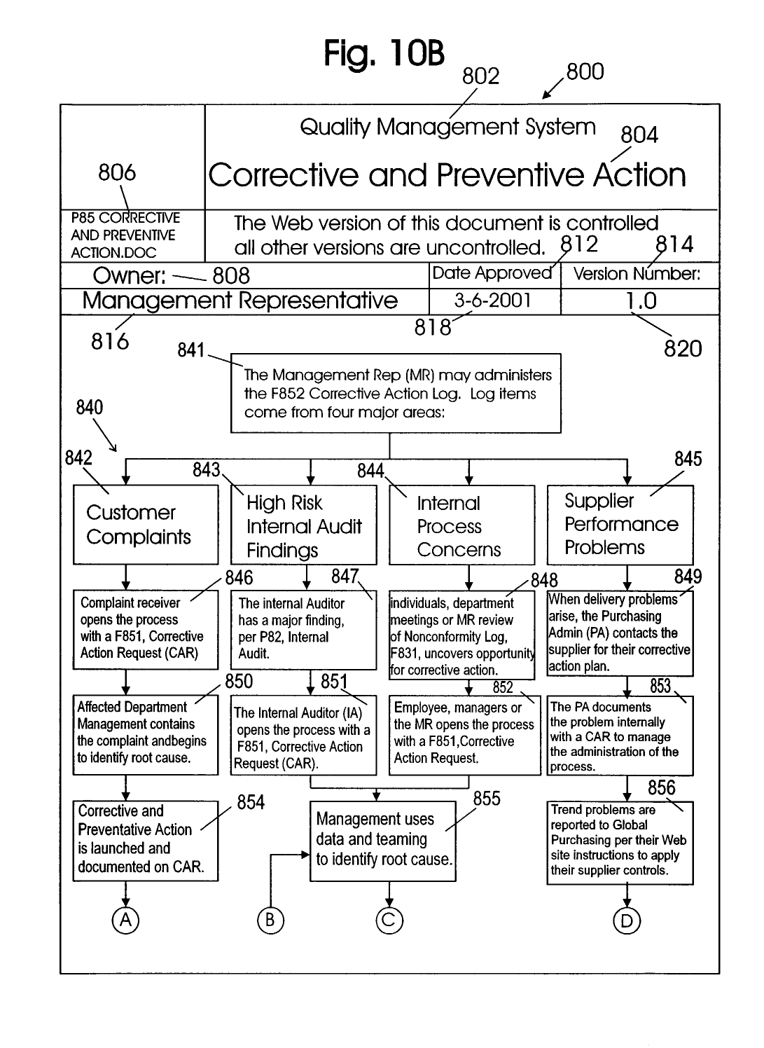

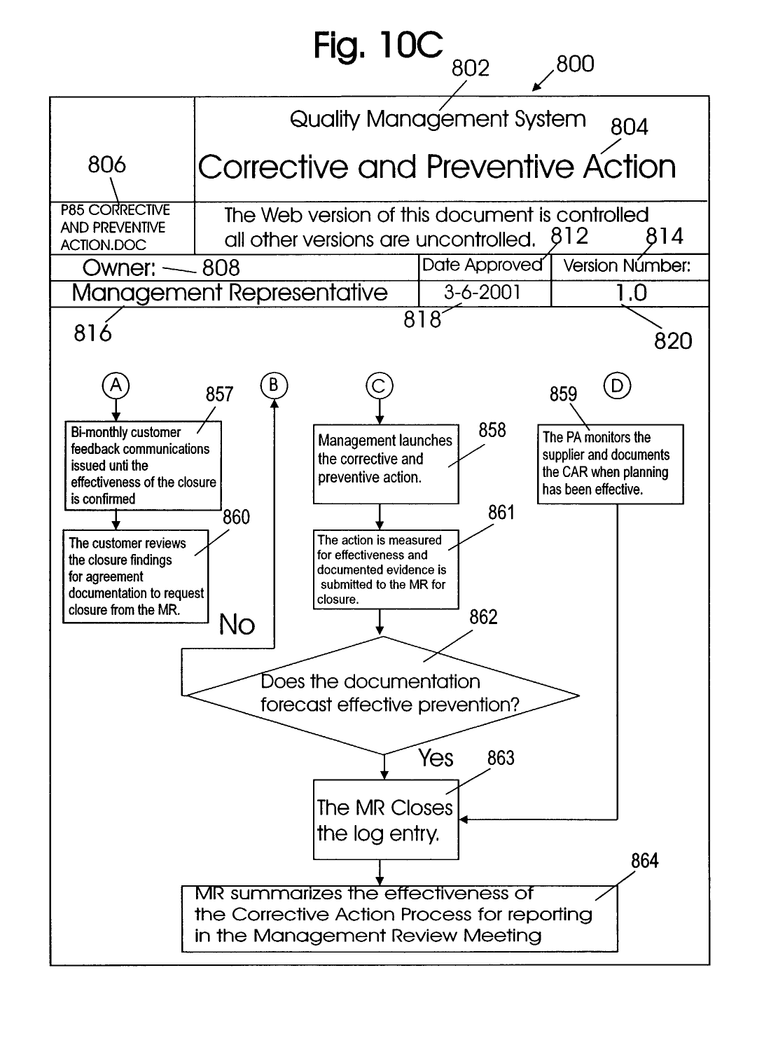

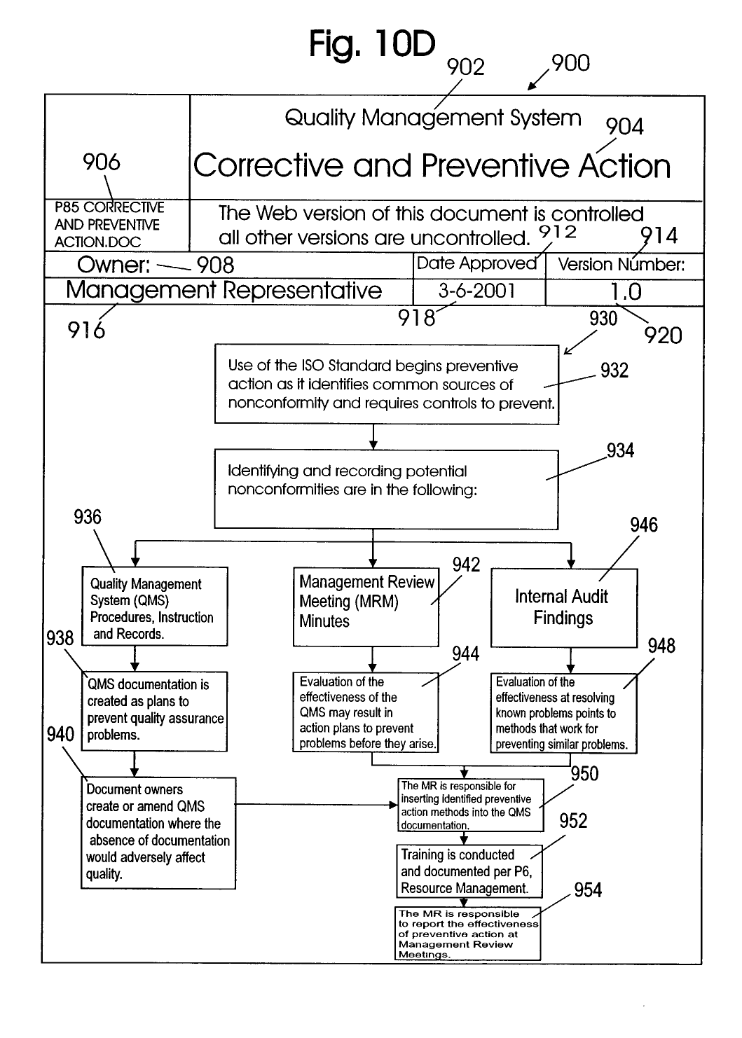

Field 422 specifies the word “Objective” and the objective of this procedure can be entered into field 424. Field 425 specifies the word “Responsibilities” and the responsibilities for this procedure can be entered into field 426. Field 428 specifies the word “Definitions” and the definitions if any for this procedure can be entered in field 429. Field 430 specifies the word “Procedure” and aspects of this procedure can be entered in field 431. Field 432 specifies the word “References” and other documents relevant to this procedure can be entered in field 434. In this case, the documents (1) N/C log, F831 (i.e. form no. 831), which is shown in FIG. 7 (2) Nonconforming Incident Trend, F832 (i.e. form 832), labeled as chart 650, which is shown in FIG. 8, (3) Nonconforming Incident Analysis, F833 (i.e. form 833), labeled as chart 670 which is shown in FIG. 9, (4) Corrective and Preventive Action P85 (i.e. procedure no. 85) which is shown in FIGS. 10A-D). These documents may be stored on the server computer 212, and may be retrieved for review and print out by the client computer 220 via the links established at the user's site (hard wire, local area network, or Internet. FIGS. 8, 9, and 10A-D will be described in more detail. Field 442 specifies the phrase “Process Change Summary” and fields 444, 448, and 452 specify the words or phrases “Date”, “Description”, and “Version No.”. Fields 446, 450 and 454 allow entry of a date, initial release and a version number, respectively for a change to this procedure, i.e. the control of nonconforming product procedure.

The flow chart sheet 500 of FIG. 6 may include fields 502, 504, 506, 508, 508, 509, 512, 514, 516, 518, and 520. Field 502 may specify the title of “Quality Management System”. Field 504 may specify the procedure, which in this example is “Control of Nonconforming Product”. Field 506 may specify an abbreviation for the procedure form, which in this case is “P83”, and a title of a computer document on which the procedure cover sheet 400 and/or the flow chart 500 for the procedure may be stored which in this case is “Control of Nonconforming Product.Doc”. Field 509 may specify that the version of the flow chart 500 on a web site or on the Internet is controlled meaning that it can be manipulated by the Web Administrator or the person or entity controlling server computer 112 or 202 and that all other versions are uncontrolled meaning there is no guarantee as to their accuracy.

Field 508 may specify the word “Owner:” and the “Owner” of the procedure can be entered into field 516, and is shown in this case as “Management Representative. The “Owner” of a procedure is the person at the company who is responsible for implementing the procedure Fields 512 and 514 specify the phrases “Date Approved” and “Version Number”, respectively. Fields 518 and 520 show the date the procedure shown by cover sheet 400 of FIG. 5 and the flow chart 500 of FIG. 6 was approved, and the version number of the procedure, respectively.

FIG. 6 also includes a flow chart 540 of a method. At step 542 of the method a process monitoring, by an employee of the company for example working under the management representative listed in field 516, may find a product which is either suspected of being nonconforming to a particular ISO standard and/or is in fact nonconforming to the particular ISO standard. At step 544 when an employee discovers a suspected nonconforming product, prior to release of the product to a customer, the employee uses his or her experience and judgment to resolve whether the product is in fact nonconforming to the company's published procedures.

At step 546, the employee upon receiving work, the employee discovering suspect or nonconforming product, rejects the work and advises management. Rejection of incoming work means the employee segregates it from acceptable work and/or sends it back for prior operation repairs. In either case, the employee moves on to other, acceptable, work. Note that sometimes the root cause of the suspected nonconforming product originates from the customer. In such as case, management may consult the contract for advice on problem resolution. If the contract is silent, the manager is responsible to document the problem and forward it to the customer contact to plan resolution. At step 548, the department management or the management representative shown in field 516, logs the incident on the N/C (“Nonconforming”) log, F831 (form numbered 831), i.e. form 600, which is shown in FIG. 7, to obtain analysis. Note that the management representative conducts and documents analysis of the N/C log for possible issue of a Corrective Action Request (“CAR”) as per procedure P85, which is the procedure for Corrective and Preventive action shown in FIG. 10. The management representative reports in the management review meeting on analysis results via the F832, Nonconforming Incident Trend Chart, FIG. 8 and the F833, Nonconforming Incident Analysis, FIG. 9.

At step 550 of the flow chart 540 of FIG. 6, the department management or the management representative shown in field 516 uses experience and judgment to resolve the nonconforming incident with a bias for preventive action. I.e. the management representative makes a determination of whether the suspected product is in fact nonconforming and what action to take if the suspected product is nonconforming. At step 552 the management representative determines is major incidents and patterns have been resolved. If so, then at step 556, employees will continue to log further incidents of suspected nonconforming product as they occur and the process begins again at step 542. If not, then at step 554 employees receiving patters of suspect or nonconforming products are authorized to issue a CAR (Corrective Action Request form) as per procedure P85, Corrective and Preventive Action, which is shown in FIG. 10.

FIG. 7 shows form 600 for nonconforming or suspected nonconforming product log entries. The form 600 of FIG. 7 may include fields 602, 604, 606, 608, 609, 610, 612, 614, 614a, 616, 616a, 618, 618a, 620, 620a, 622, and 622a. Field 602 may specify the title of “Quality Management System”. Field 604 may specify the name of the form, which in this example is “N/C Log” which stands for Nonconforming Log for entry of suspected nonconforming products. Field 606 may show a company logo. Field 608 may specify an abbreviation for the form, which in this case is “F831”, and a title of a computer document on which the form 600 may be stored which in this case is “NC LOG.DOC”. Field 609 may specify that the version of the form 600 on a web site or on the internet is controlled meaning that it can be manipulated by Web Administrator for server computer 202 of FIG. 3 and that all other versions are uncontrolled meaning there is no guarantee as to their accuracy.

Field 610 of FIG. 7 specifies directions concerning information to log into form 600. Field 612 specifies codes to log into fields 620a in the column under reason code field 620. Table 613 includes titles for each column of data and a plurality of rows for entry of a plurality of non conforming incidents. Fields 614, 616, 618, 620, and 622, specify the words “Date”, “Name”, “N/C Description”, “Reason Code”, and “Action Taken Now”, respectively. The fields 614a, 616a, 618a, 620a, and 622a, and the corresponding fields underneath the respective columns, allow for entry of a date, name, N/C description, reason code, and action taken now, respectively, for a specific incident when a product is suspected of being nonconforming to the particular ISO standard. A plurality of such entries can be entered into the plurality of rows, such as row 623 and 625, in the table 613 shown in FIG. 7. At step 104 of the flow chart 100 of FIGS. 4A-4B, a consultant provides enterprise procedures, such as the procedure of FIGS. 5 and 6 and forms in consistent format, an example of an enterprise form is form 600 shown in FIG. 7. At step 106 a consultant facilitates focus groups consisting of employees who are the “voices of the process” where they are introduced to the Standard's requirements and introduced to a compliant procedure template, such as the combination of the cover sheet 400 of FIG. 5 and the flow chart sheet 500 in FIG. 6, (or different diagram template) that is then customized to the organization's culture. Templates are customized for company titles as seen in the responsibilities section 424 of the procedure example, of cover sheet 400 in FIG. 5. At step 108 at the end of the focus group, the consultant delivers a compliant procedure for publication and training. This eliminates the finite gap analysis step of the prior art.

At step 108 compliant procedures are delivered by the internal project manager called the Management Representative to the selected organization's job titled manager who now becomes the procedure owner for purposes of publishing, training, and changing the procedure over its life. This method decentralizes the burden of the quality management system's ongoing management and expedites change request management. Compliant, enterprise procedure templates of the present invention may typically be two pages long as seen in FIG. 5 and FIG. 6. A cover sheet with purpose, responsibilities, references, and change control history, such as in cover sheet 400 in FIG. 5, is matched with a one page flowchart, such as flow chart 540 of flow chart sheet 500 in FIG. 6. Typically, the lean response ISO-9001:2000 procedures in the new, present invention have twenty-one procedures and thirty-nine forms, or less. The ISO/TS (International Standard Organization/Technical Standard) 16949:2002 procedures have thirty-five procedures and sixty-nine forms, or less in the present invention. The ISO-14000 procedures have seven procedures and fourteen forms. The quality management system of one or more embodiments of the present invention includes only ISO required procedures that the registrar uses for auditing and for registration. Any client mandated add-on procedures follow the two page model to stay lean. At step 110, internal auditing is part of the engagement at a daily rate to permit cost-per-participant to be lower as the class size is higher.

At step 112 of the method of FIGS. 4A-4B, a consultant advises training an auditor for every two procedures to keep internal auditing a part time job and to easily provide the required “independence”. At step 114 an auditor class uses the company's quality management system forms for audit findings and corrective action requests to provide in-class practice and feedback on proper completion. Progressive class size is smaller and smaller from the first case study being “open book” to the last two case studies being individual. Smaller group sessions require the group to name a facilitator who polls everyone for opinions but reserves the right to make a final determination of the findings and delivers their management report to the class. This is practice at being an Internal Lead Auditor. At step 116 the consultant includes the practice day into the project plan. The consultant observes and coaches each auditor and auditee in real audits. At step 116 the auditor conducts four “lessons learned” meetings where auditors share their experiences with the other auditors that expands everyone's knowledge base. Class slides include italic audit tips for the parts of the particular ISO standard so that when the auditor is assigned certain procedures later, they have credible areas to test to provide a comprehensive audit. At step 118, the audit class of embodiments of the present invention has pre and post testing to measure learning gain and class mastery effectiveness. At step 120 flowcharted procedures are fleshed-out to be useful as a training tool. Flowcharts, such as flow chart 540 of flow chart sheet 500 of FIG. 6, usually take six to eight minutes to cover, saving typically sixty percent in training costs and delivery time. At step 122 of the flow chart 100 of FIGS. 4A-4B, change requests go to the procedure owner who accepts, modifies, or rejects the requests and, by procedure, must reply to the requester of the decision. This process usually takes one day, or less. A quality manual is produced which is a pointing instrument that responds to the Standard by pointing to the actual procedure, such as the procedure shown by FIGS. 5-6, where compliance is demonstrated. Usually this quality manual is four to five pages in length.

At step 124, using the integration of the ISO registration system in accordance with the present invention, the electronic form management, like Liquid Office (trademarked), and using data from quality management system (QMS) forms to populate a software database like “Sequel” (trademarked), a unique system approach is provided to customers. The QMS procedures from receiving customer needs, documenting them into requirements, providing quotations, designing, producing, inspecting, and shipping are all electronic. Missing administrative steps typically will not permit further activity. Auditors and Registrars have compliant forms and reports in the database, such as database 116 of the server 112 in FIG. 2.

Quality Management Effectiveness reports are always current from the database, such as database 116 of the server 112 and available as needed for review and possible corrective action reports are available daily or even hourly. These are enterprise reports.

FIG. 8, as mentioned, shows a nonconformance incident trend chart 650 in accordance with an embodiment of the present invention. The chart 650 includes a chart 651 and a table 660. The table 660 has a row, which shows the number of monthly nonconformances of products for each month of a calendar year. The table 660 also has a row that shows the number of nonconformances year to date. The table 660 also has a row that shows the goal maximum number of nonconformances sought for a particular month. The objective is to limit the number of nonconformances, also called non-conforming products or incidents of nonconforming product. The chart 651 includes a line chart 652 and a bar chart 653. The line chart 651 includes points, such as 652a, which show the goal number of nonconformances for a particular month. Point 652a shows forty incidents of nonconforming products as a goal for the month of January. The bar chart 653 includes bars, such as bar 653a, which show the actual number of nonconformances. Bar 653a shows two incidents of nonconformances in January. The chart 650 may be maintained by a management representative as shown by data in field 662 in FIG. 8. The source of data of the chart 650 in FIG. 8 may be data entered in form 600 of FIG. 7 as also shown by the data in field 662. The chart 650 in FIG. 8 may be called F832 (i.e. form 832) as shown by data in field shown in FIG. 8. A date may be shown as part of data in field 664 in FIG. 8 to show when the chart 650 was last revised.

FIG. 9 shows a year to date nonconforming incident analysis chart 670 in accordance with an embodiment of the present invention. The chart 670 includes a table 671, a chart 672, data in field 673, and data in field 674. The table 671 shows the number of nonconforming product incidents due to various reasons. For example row 671a shows that there were six incidents of nonconforming product due to associate error (i.e. by an employee of the organization). The chart 672 is a pie chart of the data in table 671. The data in field 673 indicates that the chart 670 is maintained by a management representative and that the source of the data in table 670 is F831, NC Log (i.e. data entered in form 600 of FIG. 7). The data in field 674 indicates that chart 670 is F833 (i.e. form 833) and that it was last revised on Jul. 30, 2002.

FIG. 10A shows a cover sheet 700 for a representative procedure in accordance with an embodiment of the present invention. The cover sheet 700 of FIG. 10A may include fields 702, 704, 706, 708, 712, 714, 716, 718, 720, 722, 724, 725, 726, 728, 730, 732, 734, 736, 738, 740, 742, 744, 746, 748, 750, 752, and 754. Field 702 may specify the title of “Quality Management System”. Field 704 may specify the procedure, which in this example is “Corrective and Preventive Action”. Field 706 may specify an abbreviation for the procedure form, which in this case is “P85”, and a title of a computer document on which the procedure cover sheet 700 and/or the flow chart 800 shown in FIGS. 10B-C for the procedure may be stored which in this case is “CORRECTIVE AND PREVENTIVE ACTION.DOC”. Field 714 may specify that the version of the cover sheet 700 on a web site or on the Internet is “controlled” meaning that it can be manipulated only by the Web Administrator or person in control of server computer 112 and that all other versions are “uncontrolled”. “Uncontrolled” indicates that there is no guarantee as to the other versions accuracy.

Field 708 may specify the word “Owner:” and the “Owner” of the procedure can be entered into field 716, and is shown in this case as “Management Representative”. The “Owner” of a procedure is the specific job title at the company that is responsible for implementing the procedure. Job titles are used so that when individuals move, there is no need to change all the associated records. Fields 712 and 714 specify the phrases “Date Approved” and “Version Number”, respectively. Fields 718 and 720 show the date the procedure shown by cover sheet 700 and flow chart 800 was approved and the version number of the procedure, respectively.

Field 722 specifies the word “Objective” and the objective of this procedure can be entered into field 724. Field 725 specifies the word “Responsibilities” and the responsibilities for this procedure can be entered into field 726. Field 728 specifies the word “Definitions” and the definitions if any for this procedure can be entered in field 728a. Field 730 specifies the word “Procedure” and aspects of this procedure can be entered in field 730a. Field 732 specifies the word “References” and other documents relevant to this procedure can be entered in field 734. In this case, the documents (1) Corrective Action Request F851, which is not shown which may be a form similar to form 600 of FIG. 7, (2) a Corrective Action Request log F852, which is also not shown but which may be a form similar to form 600 of FIG. 7, (3) a Resource Management procedure P6, which is not shown but which may be a procedure similar to the procedure of FIGS. 10A-C, (4) Internal Audit P82, which is not shown but which may be a procedure similar to the procedure of FIGS. 10A-C, and (5) control on nonconforming product P83, which is shown by FIGS. 5-6). These are merely examples of forms and procedures and many other forms and procedures can be used. These forms and procedures are documents, which may be stored on the server computer 212, and may be retrieved for review and print out by the client computer 220 via the links established at the user's site (hard wire, local area network, or Internet).

FIGS. 10B and 10C show a flow chart 840 for a corrective action process. FIGS. 10B and 10C also include fields 802, 804, 806, 808, 812, 814, 816, 818, and 820 similar to fields 702, 704, 706, 708, 712, 714, 716, 718, and 720, respectively of FIG. 10A. FIGS. 10B and 10C also include flow chart 840. Flow chart 840 begins at step 841. At step 841, the management representative may administer the F852 (form “F852”) corrective action log. Log items come from four major areas: (1) customer complaints, step 842, (2) high risk internal audit findings, step 843, (3) internal process concerns, step 844 (4) and supplier performance problems, step 845.

If this is a customer complaint situation, then the complaint receiver opens the process with a F851 form, i.e. a corrective action request form, at step 846. The affected department management contains the complaint and begins to identify the root cause of the complaint, at step 850. At step 854 a corrective and preventive action is launched and documented on the corrective action request form 851. At step 857 (shown in FIG. 10C), a bimonthly customer communications feedback is issued until the effectiveness of the closure is confirmed. At step 860, the customer reviews the closure findings for agreement documentation to request closure from the MR, i.e. the management representative of the organization.

If this is a high-risk internal audit findings situation at step 843 and if the internal auditor has a major audit finding per a procedure, which may be called P82, then there is an internal audit in the organization. At step 851 the internal auditor opens the process with a form F851 corrective action request. If this is an internal process concern at step 844, then individuals, department meetings or management representative review the nonconformity log form F831 to uncover opportunity for corrective action, at step 848. At step 852 employee, managers or the management representative open the process with a form F851, Corrective Action Request.

In either the high-risk internal audit findings situation or the internal process concerns situation, management uses data and teaming to identify the root cause at step 855. Management launches the corrective and preventive action at step 858. The action is measured for effectiveness and documented evidence is submitted to the management representative for closure at step 861. At step 862 it is determined whether the documentation forecasts effective prevention. If the answer is no the procedure loops back to step 855. If the answer is yes, the management representative closes the log entry at step 863 and the management representative summarizes the effectiveness of the corrective action process for reporting in a management review meeting at step 864.

If there were supplier performance problems at step 845, then when delivery problems arise the purchasing administrator contacts the supplier for their corrective action plan, at step 849. The purchasing administrator documents the problem internally with a corrective action request to manage the administration of the process, at step 853. The trend problems are reported to global purchasing per their web site instructions to apply their supplier controls at step 856. The purchasing administrator monitors the supplier and documents the corrective action request when planning has been effective, at step 859. Step 863 is then executed.

FIG. 10D shows a flow chart 930 for a preventive action process. At step 932 the use of the particular ISO standard begins preventive action as the ISO standard identifies common sources of nonconformity and requires controls to prevent. At step 934 the identifying and recording potential nonconformities are in the following: (1) quality management system, procedures, instructions, and records; (2) management review meeting minutes; (3) internal audit findings.

Assuming there is a nonconformity in quality management system, procedures, instructions and records, step 936 and step 938 are executed. At step 938 quality management system documentation is created as plans to prevent quality assurance problems. At step 940 document owners create or amend quality management documentation where the absence of documentation would adversely affect quality Assuming there is a management review meeting minutes situation, step 942 and then step 944 are executed. At step 944 evaluation of the effectiveness of the quality management system may result in action plans to prevent problems before they arise. Assuming there is an internal audit findings situation, evaluation of the effectiveness at resolving known problems points to methods that work for preventing similar problems at step 948.

Whether steps 936, 942, or 946 are executed, eventually steps 950, 952, and 954 will be executed. Step 950 states that the management representative is responsible for inserting identified preventive action methods into the quality management system documentation. Step 952 states that the training is conducted and documented per procedure P6, for resource management. Step 954 states that the management representative is responsible to report the effectiveness of preventive action at the management review meetings.

Although the invention has been described by references to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising:
supplying an organization with information that help the organization to comply with a standard; and
wherein the information includes a flow chart, which explains how an employee of the organization should implement the standard.

2. The method of claim 1 wherein
the standard is an International Standards Organization Standard.

3. The method of claim 1 wherein
the information includes a cover sheet, which describes a particular procedure for implementing the standard.

4. The method of claim 1 wherein
the information is provided by a separate server computer to a user computer of the organization.

5. The method of claim 4 wherein
the information is provided by a separate server computer to the user computer of the organization via the Internet.

6. The method of claim 1 wherein
the information includes a cover sheet, which specifies one or more forms, which are to be used by the organization in implementing the standard.

7. The method of claim 1 wherein
the information includes a cover sheet, which specifies one or more procedures, which are to be used by the organization in implementing the standard.

8. The method of claim 1 wherein
The information includes a cover sheet, which specifies the date on which the information for implementing the standard was last updated.

9. An apparatus comprising:
a server computer has stored therein information that can help an organization to comply with a standard; and
wherein the information includes a flow chart, which explains how an employee of the organization should implement the standard

10. The apparatus of claim 9 wherein
the standard is an International Standards Organization Standard.

11. The apparatus of claim 9 wherein
the information includes a cover sheet, which describes a particular procedure for implementing the standard.

12. The apparatus of claim 9 wherein
the server computer can provide the information to a user computer of the organization.

13. The apparatus claim 12 wherein
the server computer can provide the information to the user computer of the organization via the Internet.

14. The apparatus of claim 9 wherein
the information includes a cover sheet, which specifies one or more forms, which are to be used by the organization in implementing the standard.

15. The apparatus of claim 9 wherein
the information includes a cover sheet, which specifies one or more procedures, which are to be used by the organization in implementing the standard.

16. The apparatus of claim 9 wherein
the information includes a cover sheet, which specifies the date on which the information for implementing the standard was last updated.
